(19) United States
(12) Patent Application Publication
(10) Pub. No.: US 2026/0323324 A1
(43) Pub. Date: Oct. 15, 2026

(54) IMPROVED ANALYTIC GENERATION IN A WIRELESS COMMUNICATION NETWORK

(71) Applicant: Lenovo (Singapore) Pte. Limited, Singapore (SG)

(72) Inventors: Dimitrios Karampatsis, Ruislip (GB); Ishan Vaishnavi, München (DE)

(73) Assignee: Lenovo (Singapore) Pte. Limited, Singapore (SG)

(21) Appl. No.: 18/880,912

(22) PCT Filed: Aug. 23, 2022
(86) PCT No.: PCT/EP2022/073505

§ 371 Date: Jan. 3, 2025

(30) Foreign Application Priority Data
Jul. 4, 2022 (GR) 20220100533

(51) Int. Cl. H04W 24/08

(52) U.S. Cl. CPC H04W 24/08

(57) ABSTRACT

There is provided a Network Data Analytics Function (NWDAF) in a wireless communication network, the NWDAF comprising a transceiver and a processor. The transceiver is arranged to receive a request for analytics, the request for analytics comprising a network analytics identifier. The processor is arranged to identify from the request for analytics at least one network function to collect data from. The transceiver is further arranged to send a request to a management entity, the request comprising a request for fault information within the wireless communication network. The transceiver is further arranged to receive fault information from the management entity, the fault information comprising the identity of the particular network function, the nature of a fault and a time period where the fault affects the operation of the particular network function. The processor is further arranged to determine if the accuracy of collected data from the network function is affected by the fault information, and to disregard any collected data from the network function that is affected by the fault. The transceiver is further arranged to send, in response to the request for analytics, analytics and an indication as to which analytics are affected by the fault.

### FIELD

The subject matter disclosed herein relates generally to the field of implementing improved analytic generation in a wireless communication network. This document defines a Network Data Analytics Function and a method in a Network Data Analytics Function.

### BACKGROUND

Faults can occur in a wireless communication network and by their nature these faults disrupt the normal operation of the wireless communication network. Analytics for network nodes affected by the fault and collected during operation of the wireless communication network during such a fault are not representative of the normal operation of the wireless communication network. Thus, any operational decisions based on such fault affected analytics may not be optimized for the normal operation of the wireless communication network.

### SUMMARY

There is presented herein an arrangement whereby fault affected analytics are identified such that accurate analytics may be derived. Such accurate analytics may be used to make operational decisions for the wireless communication network, and thus improve the normal operation of the wireless communication network.

Disclosed herein are procedures for improved analytic generation in a wireless communications network. Said procedures may be implemented by a Network Data Analytics Function and a method in a Network Data Analytics Function.

Accordingly, there is provided a Network Data Analytics Function (NWDAF) in a wireless communication network, the NWDAF comprising a transceiver and a processor. The transceiver is arranged to receive a request for analytics, the request for analytics comprising a network analytics identifier. The processor is arranged to identify from the request for analytics at least one network function to collect data from. The transceiver is further arranged to send a request to a management entity, the request comprising a request for fault information within the wireless communication network. The transceiver is further arranged to receive fault information from the management entity, the fault information comprising the identity of the particular network function, the nature of a fault and a time period where the fault affects the operation of the particular network function. The processor is further arranged to determine if the accuracy of collected data from the network function is affected by the fault information, and to disregard any collected data from the network function that is affected by the fault. The transceiver is further arranged to send, in response to the request for analytics, analytics and an indication as to which analytics are affected by the fault.

There is further provided a method in a Network Data Analytics Function (NWDAF), the NWDAF in a wireless communication network. The method comprises receiving a request for analytics, the request for analytics comprising a network analytics identifier; and identifying from the request for analytics at least one network function to collect data from. The method further comprises sending a request to a management entity, the request comprising the identity of a particular network function and a request for fault information within the wireless communication network; and receiving fault information from the management entity, the fault information comprising the identity of the particular network function, the nature of a fault and a time period where the fault affects the operation of the particular network function. The method further comprises determining if the accuracy of collected data from the network function is affected by the fault information and disregarding any collected data from the network function that is affected by the fault; and sending, in response to the request for analytics, analytics and an indication as to which analytics are affected by a fault.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for improved analytic generation in a wireless communications network will now be described, by way of example only, with reference to the accompanying drawings, in which:

FIG. 1 depicts an embodiment of a wireless communication system for improved analytic generation in a wireless communication network;

FIG. 2 depicts a user equipment apparatus that may be used for implementing the methods described herein;

FIG. 3 depicts further details of the network node that may be used for implementing the methods described herein;

FIG. 4 illustrates an approach to deriving and providing analytics to Analytics Consumer Network Functions;

FIG. 5 illustrates a Management Data Analytics Function comprising internal business logic associated with Management Data Analytics;

FIG. 6 illustrates a system wherein an NWDAF subscribes from an MDAF/MDAS to receive information about possible faults in a core network;

FIG. 7 illustrates a method for improving analytics by interacting with MDAS/MDAF for fault prediction; and

FIG. 8 illustrates a method in a Network Data Analytics Function.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

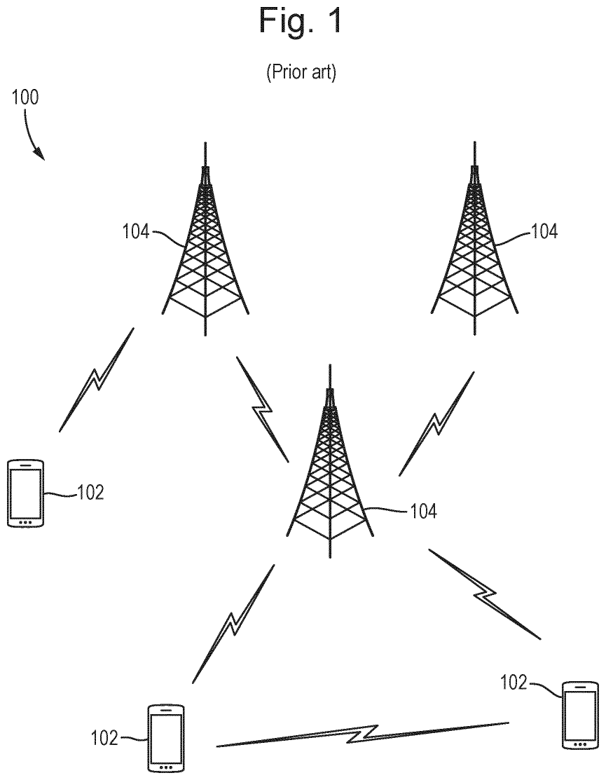

FIG. 1 depicts an embodiment of a wireless communication system 100 for improved analytic generation in a wireless communications network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

Currently when a consumer requests analytics from an NWDAF the consumer may include in the request a target area and/or a target UE or group of UE(s). The NWDAF derives analytics by collecting data/events from one or more Network Functions ensuring the data are from the target area requested or involve the target UE(s). The analytics are derived taking into account a static location of UEs based on AMF determining a UE entering or leaving a specific area of interest with a granularity of Tracking Area(s) or Cell ID(s).

Faults can occur in a wireless communication network and by their nature these faults disrupt the normal operation of the wireless communication network. Analytics for network nodes affected by the fault and collected during operation of the wireless communication network during such a fault are not representative of the normal operation of the wireless communication network. Thus, any operational decisions based on such fault affected analytics may not be optimized for the normal operation of the wireless communication network. Accordingly, there is presented herein an arrangement whereby fault affected analytics are identified such that accurate analytics may be derived. Such accurate analytics may be used to make operational decisions for the wireless communication network, and thus improve the normal operation of the wireless communication network.

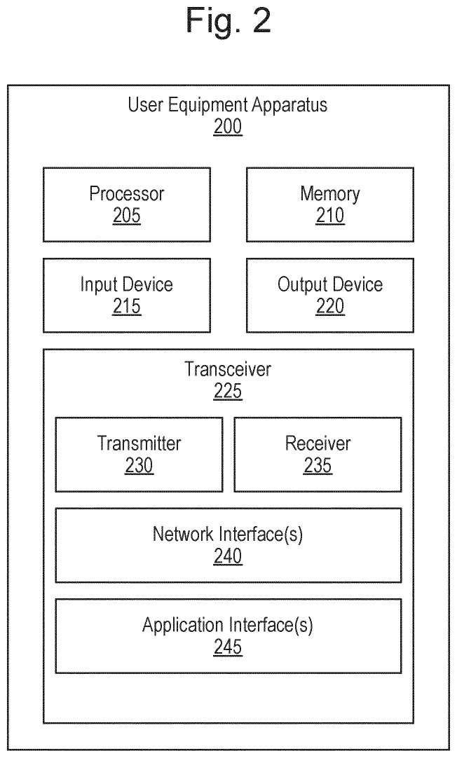

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, a UE 440, or a consumer 705 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module.

Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

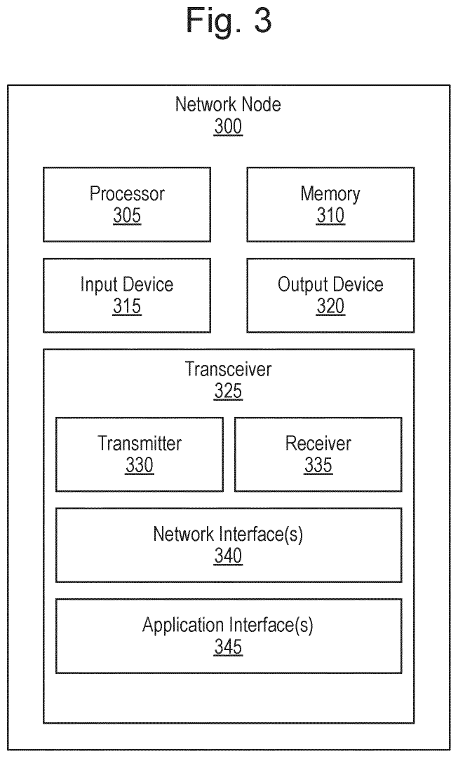

FIG. 3 depicts further details of the network node 300 that may be used for implementing the methods described herein. The network node 300 may be one implementation of an entity in the wireless communications network, e.g. in one or more of the wireless communications networks described herein. The network node 300 may be, for example, a network unit 104, or an NWDAF 410, 420, 620, 720 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

Currently when a consumer requests analytics from an NWDAF the consumer may include in the request a target area and/or a target UE or group of UE(s). The NWDAF derives analytics by collecting data/events from one or more Network Functions ensuring the data are from the target area requested or involve the target UE(s). The analytics are derived taking into account a static location of UEs based on AMF determining a UE entering or leaving a specific area of interest with a granularity of Tracking Area(s) or Cell ID(s).

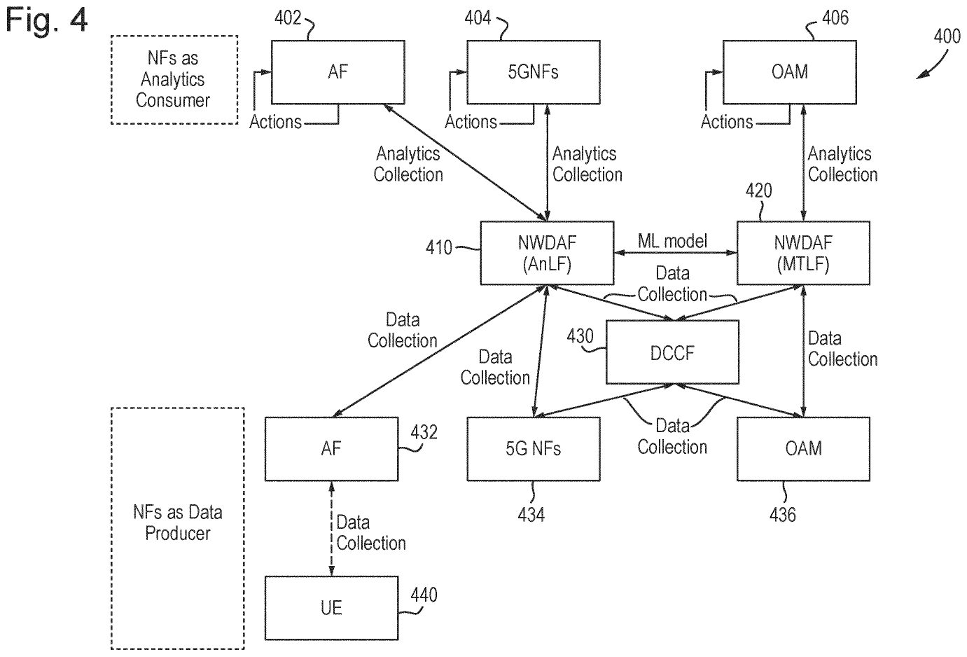

FIG. 4 illustrates an approach to deriving and providing analytics to Analytics Consumer Network Functions. This approach is defined in the current Release 16 and Release 17 3GPP architecture the NWDAF (defined in 3GPP TS 23.288 v17.2.0) provides analytic output to one or more Analytics Consumer NIFs based on Data Collected from one or more Data Producer NFs. FIG. 4 illustrates a system 400 comprising network functions operating as analytics consumers, these comprise an application function (AF) 402, a 5G network function (5GNF) 404, an Operations, Administration and Maintenance (OAM) 406. The system 400 further comprises a Network Data Analytics Function (NWDAF) having an Analytics Inference Logical Function (AnLF) 410, a Network Data Analytics Function (NWDAF) having an Model Training Logical Function (MTFL) 420, and a Data Collection Coordination Functionality (DCCF) 430. The system 400 further comprises network functions operating as data producers, these comprise an application function (AF) 432, a 5G network function (5GNF) 434, an Operations, Administration and Maintenance (OAM) 436, and a User Equipment (UE) 440. The user equipment 440 may comprise a user equipment apparatus 200 a remote unit 102, a UE 440, or a consumer 705 as described herein. The NWDAFs 410, 420 may comprise the network unit 104, the network node 300, or an NWDAF 620, 720, as described herein.

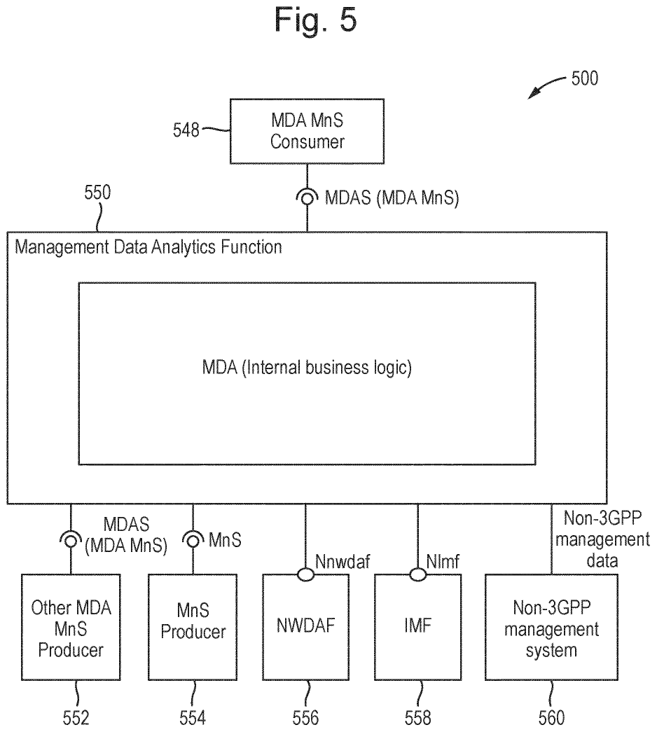

Analytics are also generated at the management plane. Management Data Analytics (MDA), is an enabler of automation and intelligence for services management and orchestration. An MDA MnS (also referred to as MDAS) defined in 3GPP TS 28.102 v2.0.0 enables any authorized consumer to request and receive analytics. FIG. 5 illustrates a Management Data Analytics Function (MDAF) 550 comprising internal business logic associated with Management Data Analytics. MDAF 550 interfaces with an MDA Management Service (MnS) Consumer 548. MDAF 550 also interfaces with a plurality of producers, such as Other MDA MnS Producer 552, an MNS producer 554, an NWDAF 556, a location management function (LMF) 558, and a non-3GPP management system 560.

A management function (MDAF) may play the roles of MDA MnS producer, MDA MnS consumer, other MnS consumer, NWDAF consumer and LMF service consumer, and may also interact with other non-3GPP management systems.

The internal business logic related to MDA leverages the current and historical data related to:
Performance Measurements (PM) as per TS 28.552 and Key Performance Indicators (KPIs) as per TS 28.554.
Trace data, including MDT/RLF/RCEF, as per TS 32.422 and TS 32.423.
QoE and service experience data as per TS 28.405 and TS 28.406.
Analytics data offered by NWDAF as per TS 23.288 including 5GC data and external web/app-based information (e.g., web crawler that provides online news) from AF.
Alarm information and notifications as per TS 28.532.
CM information and notifications.
UE location information provided by LMF as per TS 23.273.
MDA reports from other MDA MnS producers.
Management data from non-3GPP systems.

Analytics output from the MDA internal business logic are made available by the management functions (MDAFs) playing the role of MDA MnS producers to the authorized consumers, (including but not limited to other management functions, network functions/entities, NWDAF, SON functions, optimization tools and human operators).

The analytics provided by MDAS include analytics for fault management predictions/statistics or generally the MDA can assist in fault management. The MDA can supervise the status of various network functions and resources, and predict the running trend of network and potential failures to intervene in advance. These predictions can be used by the management system to autonomously maintain the health of the network, e.g., speedy recovery actions on a network function related to the predicted potential failure.

As part of the analytic output the following information elements can be provided by the MDAF. Table 1 indicates analytics output for fault prediction analysis as defined in 3GPP TS 28.104 v17.0.1.

TABLE 1
Analytics output for fault prediction analysis

| | | Support | |
|---|---|---|---|
| Information element | Definition | qualifier | Properties |
| failurePredictionObject | Indication of NR cells or NFs where | M | type: DN |
| | the failure related issues occurred or | | multiplicity: 1 . . . * |
| | potentially occur. | | isOrdered: N/A |
| | | | isUnique: N/A |
| | | | defaultValue: None |
| | | | isNullable: False |
| potentialFailureType | Indication of type of issues that can | M | type: string |
| | cause the failures. | | multiplicity: 1 |
| | NOTE: The values can be defined as | | isOrdered: N/A |
| | a list of example values: “Operational | | isUnique: N/A |
| | Violation”, “Physical Violation” and | | defaultValue: None |
| | “Time Domain Violation”. See | | isNullable: False |
| | alarmType described in TS 28.532. | | |
| eventTime | This field holds the time of potential | M | type: DateTime |
| | failure predicted. | | multiplicity: 1 |
| | Examples: “20:15:00”, “20:15:00-08:00” | | isOrdered: N/A |
| | (for 8 hours behind UTC). | | isUnique: N/A |
| | | | defaultValue: None |
| | | | isNullable: False |
| issueID | This filed holds the ID of this failure | M | type: string |
| | prediction which is reported. | | multiplicity: 1 |
| | When reports, this identifier can be | | isOrdered: N/A |
| | used to provide the information to | | isUnique: N/A |
| | management system to maintain. | | defaultValue: None |
| | | | isNullable: False |
| perceivedSeverity | This field holds the value to indicate | M | type: ENUM |
| | relative level of urgency for operator | | multiplicity: 1 |
| | attention. | | isOrdered: N/A |
| | NOTE: the value can be Critical, Major, | | isUnique: N/A |
| | Minor, Warning, Indeterminate, Cleared, | | defaultValue: None |
| | see ITU-T Recommendation X.733. | | isNullable: False |

There is presented herein a definition of the interactions between NWDAF and MDAS/MDAF, and examples of how these might be used. For example, the analytics from MDAS can assist analytics generation from NWDAF.

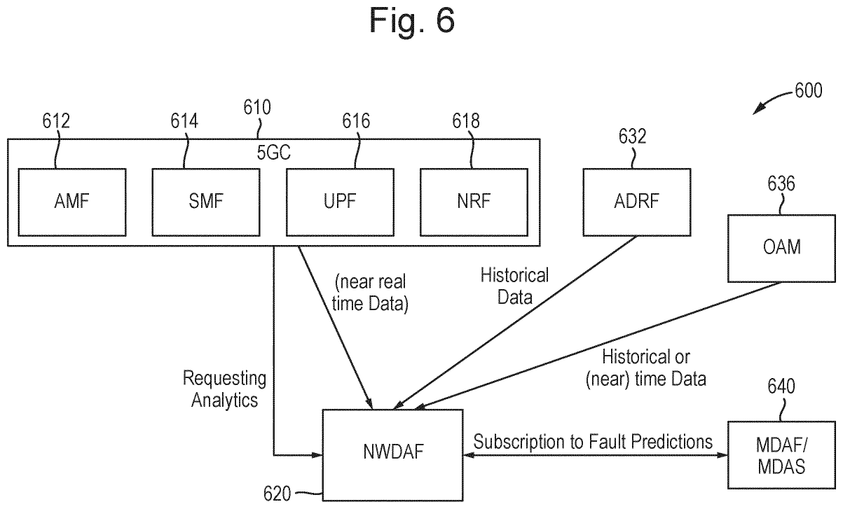

FIG. 6 illustrates a system 600, wherein an NWDAF 620 subscribes from the MDAF/MDAS 640 to receive information about possible faults in the core network 610. System 600 comprises a 5G core 610, an ADRF 632, an OAM 636, NWDAF 620 and MDAF/MDAS 640. The 5G core 610 comprises an Access and Mobility management Function (AMF) 612, a session management function (SMF) 614, a user plane function (UPF) 616, and a Network Repository Function (NRF) 618. The NWDAF 620 may comprise the network unit 104, the network node 300, or an NWDAF 410, 420, 720, as described herein.

The NWDAF 620 uses the analytic output from the MDAF/MDAS 640 to verify and/or determine the analytics accuracy. The NWDAF 620 may need input from the MDAF/MDAS 640 to verify analytics accuracy, for example, when generating analytics using the ML model and data from corresponding data producers based on the analytics requested by a consumer. The NWDAF 620 may need input from the MDAF/MDAS 640 when notifying analytics consumer(s) about analytics inaccuracy in case the NWDAF 620 is informed of these by the MDAS/MDAF 640.

The request from the NWDAF 620 to the MDAF/MDAS 640 about fault prediction and/or statistics may depend on the analytics requested by an analytics consumer. A consumer requests analytics identified by a specific analytic ID and the analytics request may have one or more parameters as analytics filters. Table 2 shows potential parameters that can be requested by the NWDAF 620 from the MDAF/MDAS 640 when requesting fault prediction analytics. These parameters may be used as filters to filter the available information.

TABLE 2
Potential fault prediction requested parameters

| | | | Potential parameters |
|---|---|---|---|
| | | | requested to the |
| | | Data | MDAS/MDAF for fault |
| Analytics ID | Analytics Filters | Producers | prediction |
| Slice load | S-NSSAI and NSI ID | OAM, AMF, | Provide fault prediction for a |
| level related | Area of interest | SMF, | specific Area of Interest. (e.g. |
| network data | List of NF types | NSACF, | cell ID, traffic area or |
| analytics | Load Level | NRF | geographical area) |
| | Threshold value | | Includes a list of NF types (e.g. |
| | | | AMF, SMF) or a list of NF IDs |
| | | | based on the AMF and SMF |
| | | | used by the NWDAF to collect |
| | | | data for analytics. |
| | | | Include a specific Slice identified |
| | | | by S-NSSAI and/or NSI ID |
| Observed Service | Target of Analytics | AF, AMF, | Provide fault prediction for a |
| Experience | Reporting: one or | SMF, UPF | specific Area of Interest. (e.g. |
| related network | more SUPI(s) or | | cell ID, traffic area or |
| data analytics | Internal Group | | geographical area) |
| | Identifier(s), or “any | | Includes a list of NF types (e.g. |
| | UE”; Application ID; | | AMF, SMF) or a list of NF IDs |
| | S-NSSAI; NSI ID(s); | | based on the AMF and SMF |
| | Area of Interest; | | used by the NWDAF to collect |
| | DNN; DNAI; RAT | | data for analytics. |
| | Type; Frequency; | | Include a specific Slice identified |
| | Application Server | | by S-NSSAI and/or NSI ID |
| | Address(es); | | |
| | UPF anchor ID; | | |
| NF load | Target of Analytics | NRF, OAM | Provide fault prediction for a |
| analytics | Reporting: an optional | | specific Area of Interest. (e.g. |
| | SUPI or any UE; | | cell ID, traffic area or |
| | S-NSSAI; list of NF | | geographical area) |
| | Instance IDs, NF Set | | Includes a list of NF types (e.g. |
| | IDs, or NF types; | | AMF, SMF) or a list of NF IDs |
| | area of interest; | | based on the AMF and SMF |
| | | | used by the NWDAF to collect |
| | | | data for analytics. |
| | | | Include a specific Slice identified |
| | | | by S-NSSAI and/or NSI ID |
| Network | Target of Analytics | OAM, | Provide fault prediction for a |
| Performance | Reporting: an optional | NRF | specific Area of Interest. (e.g. |
| Analytics | SUPI or any UE; | | cell ID, traffic area or |
| | Area of Interest (list | | geographical area) |
| | of TA or Cells) which | | |
| | restricts the area | | |
| | in focus | | |
| UE related | Target of Analytics | AMF, | Provide fault prediction for a |
| analytics | Reporting: an optional | SMF, UPF | specific Area of Interest. (e.g. |
| UE mobility | SUPI or any UE; | | cell ID, traffic area or |
| analytics | Area of Interest (list | | geographical area) |
| UE | of TA or Cells) which | | Includes a list of NF types (e.g. |
| communication | restricts the area | | AMF, SMF) or a list of NF IDs |
| analytics | in focus | | based on the AMF and SMF |
| Expected UE | | | used by the NWDAF to collect |
| behavioural | | | data for analytics. |
| parameters | | | |
| Abnormal UE | | | |
| behaviour | | | |
| User Data | Target of Analytics | AMF, | Provide fault prediction for a |
| Congestion | Reporting: an optional | UPF, OAM | specific Area of Interest. (e.g. |
| Analytics | SUPI or any UE; | | cell ID, traffic area or |
| | S-NSSAI; list of NF | | geographical area) |
| | Instance IDs, NF Set | | Includes a list of NF types (e.g. |
| | IDs, or NF types; | | AMF, UPF) or a list of NF IDs |
| | area of interest; | | based on the AMF and UPF |
| | | | used by the NWDAF to collect |
| | | | data for analytics. |
| | | | Include a specific Slice identified |
| | | | by S-NSSAI and/or NSI ID |
| QoS | Area of interest; | OAM | Provide fault prediction for a |
| Sustainability | S-NSSAI | (RAN UE | specific Area of Interest. (e.g. |
| Analytics | | throughput, | cell ID, traffic area or |
| | | QoS flow | geographical area) |
| | | trainability) | Include a specific Slice identified |
| | | | by S-NSSAI and/or NSI ID |
| Dispersion | Target of Analytics | AMF, | Provide fault prediction for a |
| Analytics | Reporting: a single | SMF, AF | specific Area of Interest. (e.g. |
| | UE, any UE, or a | | cell ID, traffic area or |
| | group of UEs. “Any | | geographical area) |
| | UE” is only supported | | Include a specific Slice identified |
| | in combination with | | by S-NSSAI and/or NSI ID |
| | Analytics Filter | | |
| | Information S-NSSAI | | |
| | and Dispersion | | |
| | Analytics type “Data | | |
| | Volume Dispersion | | |
| | Analytics”; optional | | |
| | list of TA(s), Area(s) | | |
| | of Interest, Cells, or | | |
| | S-NSSAI(s), | | |
| | Application ID(s), | | |
| | Top-Heavy UEs, | | |
| | Fixed UEs, Camper | | |
| | UEs, Dispersion | | |
| | Analytics type (Data | | |
| | Volume Dispersion | | |
| | Analytics (DVDA) | | |
| | or Transactions | | |
| | Dispersion Analytics | | |
| | (TDA) or both); | | |
| WLAN | Area of interest | SMF | Provide fault prediction for a |
| performance | | | specific Area of Interest. (e.g. |
| analytics | | | cell ID, traffic area or |
| | | | geographical area) |
| | | | (in case an SMF that handles |
| | | | non-3GPP access PDU session |
| | | | has a fault) |
| Session | Target of Analytics | AMF | Provide fault prediction for a |
| Management | Reporting: a single | | specific Area of Interest. (e.g. |
| Congestion | UE, any UE, or a | | cell ID, traffic area or |
| Control | group of UEs; | | geographical area) |
| Experience | Area of Interest; | | Include an AMF ID of the AMF |
| Analytics | | | serving the UE |
| Redundant | Target of Analytics | OAM, | Provide fault prediction for a |
| Transmission | Reporting: a single | UPF, SMF | specific Area of Interest. (e.g. |
| Experience | UE, any UE, or a | | cell ID, traffic area or |
| related | group of UEs.; | | geographical area) |
| analytics | Area of Interest; | | Include a specific Slice identified |
| | S-NSSAI; DNN | | by S-NSSAI and/or NSI ID |
| DN Performance | Target of Analytics | AF, UPF | Provide fault prediction for a |
| Analytics | Reporting: a single | | specific Area of Interest. (e.g. |
| | UE, any UE, or a | | cell ID, traffic area or |
| | group of UEs; | | geographical area) |
| | | | Include a specific Slice identified |
| | | | by S-NSSAI and/or NSI ID |
| | | | Include a UPF ID (or instance ID) |

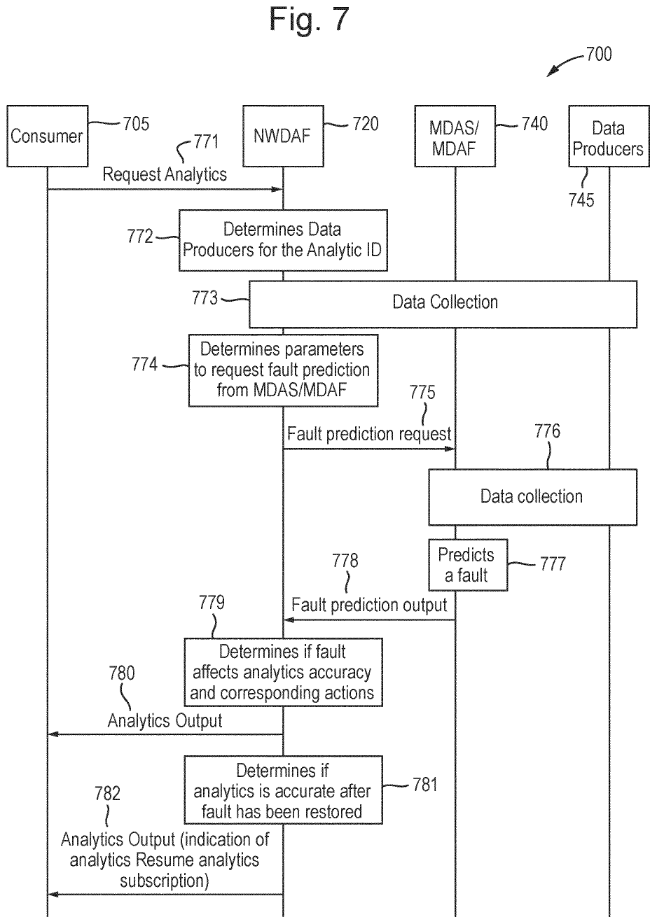

FIG. 7 illustrates a method 700 for improving analytics by interacting with MDAS/MDAF for fault prediction. FIG. 7 illustrates an analytics consumer 705, an NWDAF 720, an MDAS/MDAF 740 and a data producer 745. The analytics consumer 705 may comprise the remote unit 102, the user equipment apparatus 200, or a UE 440 as described herein. The NWDAF 720 may comprise the network unit 104, the network node 300, or an NWDAF 410, 420, 620, as described herein.

The method 700 begins at 771, the consumer 705 requests analytics including an analytic ID as per 3GPP TS 23.288. For example, a consumer can request analytics for an analytic ID for NF load. The request may comprise at least one parameter as described in Table 2.

At 772, the NWDAF 720 determines the Data Producer(s) 745 from which to collect data to derive analytics for the analytic ID requested.

At 773, the NWDAF 720 collects data from the identified data producer(s).

At 774, the NWDAF 720 determines the parameters required when requesting fault predictions from the MDAS/MDAF 740 as per Table 2.

At 775, the NWDAF 720 subscribes to the MDAS/MDAF 740 for fault prediction.

At 776, the MDAS/MDAF 740 determines data producers and collects data.

At 777, the MDAS/MDAF 740 may determine a fault based on analytics generated.

At 778, the MDAS/MDAF 740 reports a fault prediction to the NWDAF 720. The analytic output may include one or more parameters listed in Table 1, such as indication of analytics Inaccuracy, pause analytics subscription.

At 779, the NWDAF 720 determines, based on the information provided in step 778, if the fault affects the accuracy of the analytics. The NWDAF 720 can determine if the fault affects the inference model for generating analytics or whether the analytics predictions that are already provided to a consumer are inaccurate due to the predictions or statistics provided by the MDAS/MDAF 740.

One method for the NWDAF 720 to estimate how the analytics accuracy is affected is as follows: If the fault prediction includes an NF identity (NF id or NF instance ID) indicating that the network function will be “misbehaving” (operating abnormally) for a specific period of time the NWDAF 720 can disregard the data for the time duration where the NF is “misbehaving” and collect data from the NF when the NF is operating at its nominal conditions. Based on the data disregarded the NWDAF 720 can estimate how the analytics accuracy is affected (i.e. the NWDAF 720 will have less number of samples to generate analytics) and indicate to the consumer if the analytics accuracy is affected. If the NWDAF 720 determines that the analytics are not affected by the fault prediction (e.g. the NF was at fault only for a small period of time and the NWDAF 720 has enough samples to generate analytics at a requested accuracy) the NWDAF 720 does not need to report to the consumer an indication that the analytics are not accurate.

The NWDAF 720 may also use statistical information provided by the MDAS/MDAF 740. Such statistical information may comprise the MDAS/MDAF 740 notifying the NWDAF 720 of an imminent network failure. If the NWDAF 720 determines that fault indication will affect the analytics accuracy then the NWDAF 720 notifies the consumer to stop using the analytics provided by the NWDAF 720 until the network failure is resolved.

At 780, if the NWDAF 720 determines that the fault analytics information affects the accuracy of the analytics the NWDAF 720 reports to the consumer an indication to stop making decisions. The NWDAF 720 may include a pause indication to the consumer 705.

At 781, the NWDAF 720 determines that the analytics accuracy is restored, after the NWDAF 720 has accumulated enough samples from the Data Producer(s) 745 where faults were predicted, the accumulated samples uncontaminated by faults.

At 782, the NWDAF 720 indicates to the consumer 705 to resume the analytics subscription.

The above example specified the collection of network analytics. However, the arrangements described herein may also be applied to the training of a machine learning (ML) model, the training taking into account fault predictions from MDAS/MDAF 740. The estimation of the accuracy of an ML model is determined by receiving input from the MDAS/MDAF when the MTLF trains an ML model. When the NWDAF MTLF is triggered to train an ML model the NWDAF determines the Data producers to obtain data to train the model according to the analytic ID. The NWDAF MTLF may also subscribe to the MDAS/MDAF to receive notifications for fault predictions/statistics in the area served by the data producer, or if the identified data producer NF that provides the data for the model training is at fault (identified by including the NF ID in the fault prediction request to the MDAS/MDAF).

If the MDAS/MDAF provides a fault prediction the NWDAF MTLF disregards the data collected for training the ML model based on the information provided in the fault prediction and re-train the ML model using data from the data producer where a fault is not predicted. For example, if the fault prediction from the MDAS/MDAF indicates that a fault is predicted for an NF for a specific time period the MTLF will disregard any data collected from this NF collected at the time period where a fault is predicted.

If the MDAS/MDAF notifies the NWDAF MTLF about a fault situation based on statistical information the MDAS/MDAF may decide to re-train the ML model using data from data producers affected by the fault after the fault is resolved. The NWDAF can be made aware of when the fault is resolved based on the event time providing in the analytic output of the MDAS/MDF.

Such a procedure differs from FIG. 7 in that the NWDAF is specifically an NWDAF MTLF, and the Consumer is specifically an NWDAF AnLF. The analytics requested at step 771 of FIG. 7 are specifically for a an ML model for an analytic ID. The AnLF (here the consumer) may include in the request to provide an ML model at a requested time. In step 780, if the fault affects the ML model training and the MTLF cannot provide the ML model at a requested time, the MTLF indicates to the AnLF that the ML model will not be available at the requested time.

Accordingly, there is provided a Network Data Analytics Function (NWDAF) in a wireless communication network, the NWDAF comprising a transceiver and a processor. The transceiver is arranged to receive a request for analytics, the request for analytics comprising a network analytics identifier. The processor is arranged to identify from the request for analytics at least one network function to collect data from. The transceiver is further arranged to send a request to a management entity, the request comprising a request for fault information within the wireless communication network. The transceiver is further arranged to receive fault information from the management entity, the fault information comprising the identity of the particular network function, the nature of a fault and a time period where the fault affects the operation of the particular network function. The processor is further arranged to determine if the accuracy of collected data from the network function is affected by the fault information, and to disregard any collected data from the network function that is affected by the fault. The transceiver is further arranged to send, in response to the request for analytics, analytics and an indication as to which analytics are affected by the fault.

Faults can occur in a wireless communication network and by their nature these faults disrupt the normal operation of the wireless communication network. Analytics for network nodes affected by such a fault and collected during operation of the wireless communication network during such a fault are not representative of the normal operation of the wireless communication network. Thus, any operational decisions based on such fault affected analytics may not be optimized for the normal operation of the wireless communication network. Accordingly, there is presented herein an arrangement whereby fault affected analytics are identified such that accurate analytics may be derived. Such accurate analytics may be used to make operational decisions for the wireless communication network, and thus improve the normal operation of the wireless communication network.

The fault may be a predicted fault, whereby data analysis indicates that a fault will occur in a particular network function at a particular time, or whereby data analysis indicates that a fault has occurred in a particular network function at a particular time. The data analysis may be a statistical analysis. The fault may be a detected fault whereby a fault is identified by the management function.

The wireless communication network may be a 5G network. The information request sent to the management entity may comprise the identity of a particular network function.

The request for analytics may comprise a request for a trained machine learning model associated with the network analytics identifier.

The processor may be arranged to disregard any collected data from the network function that is affected by the fault, by making a determination that the trained machine learning model requires retraining.

The request for analytics may comprise a request for network analytics corresponding to at least one of the network analytics identifier; a network function identity of the network function where data is collected, and/or a target area.

The request for analytics may include conditions. The conditions may comprise any combination of a target UE, an area of interest, or a list of S-NSSAI, for example. The analytics may be identified by an analytic ID.

The request for analytics information may be a subscription request.

The request for fault information may be derived from the request for analytics. For example, where the request for analytics includes conditions to provide analytics, then these conditions are used to create the request for fault information. The request for fault information may comprise a list of network functions.

The indication as to which analytics are affected by the fault may comprise an indication of the analytics for which the accuracy is affected for the period where the fault occurs.

The indication as to which analytics are affected by the fault may comprise an indication of a time period for which the accuracy of the analytics is affected where the fault occurs. The identity of the particular network function may be defined as a target area, wherein the target area is served by the particular network function. Where the fault affects a plurality of network functions, the plurality of network functions may be defined as a target area, the target area served by the plurality of network functions.

The indication as to which analytics are affected by the fault may comprise an indication of a target area of a plurality of network functions for which the accuracy of the analytics is affected where the fault occurs.

The fault may affect more than the particular network function, in which case the fault information may comprise a target area whereby the fault affects the operation of the of a set of network functions serving the target area. The particular network function may be a member of the set of network functions serving the target area. The fault information may comprise a list of the set of network functions affected by the fault.

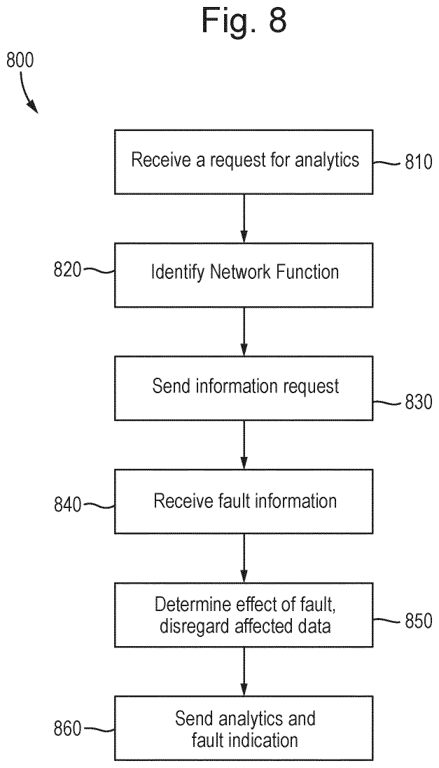

FIG. 8 illustrates a method 800 in a Network Data Analytics Function (NWDAF), the NWDAF in a wireless communication network. The method 800 comprises receiving 810 a request for analytics, the request for analytics comprising a network analytics identifier; and identifying 820 from the request for analytics at least one network function to collect data from. The method 800 further comprises sending 830 a request to a management entity, the request comprising the identity of a particular network function and a request for fault information within the wireless communication network; and receiving 840 fault information from the management entity, the fault information comprising the identity of the particular network function, the nature of a fault and a time period where the fault affects the operation of the particular network function. The method 800 further comprises determining 850 if the accuracy of collected data from the network function is affected by the fault information, and disregarding any collected data from the network function that is affected by the fault; and sending 860, in response to the request for analytics, analytics and an indication as to which analytics are affected by a fault.

Faults can occur in a wireless communication network and by their nature these faults disrupt the normal operation of the wireless communication network. Analytics for network nodes affected by the fault and collected during operation of the wireless communication network during such a fault are not representative of the normal operation of the wireless communication network. Thus, any operational decisions based on such fault affected analytics may not be optimized for the normal operation of the wireless communication network. Accordingly, there is presented herein an arrangement whereby fault affected analytics are identified such that accurate analytics may be derived. Such accurate analytics may be used to make operational decisions for the wireless communication network, and thus improve the normal operation of the wireless communication network.

The fault may be a predicted fault, whereby data analysis indicates that a fault will occur in a particular network function at a particular time, or whereby data analysis indicates that a fault has occurred in a particular network function at a particular time. The data analysis may be a statistical analysis. The fault may be a detected fault whereby a fault is identified by the management function.

The wireless communication network may be a 5G network. The information request sent to the management entity may comprise the identity of a particular network function.

The request for analytics may comprise a request for a trained machine learning model, the trained machine learning model trained using training data associated with the network analytics identifier.

Disregarding any collected data from the network function that is affected by the fault may comprise making a determination that the trained machine learning model requires retraining.

The request for analytics may comprise a request for network analytics corresponding to at least one of the network analytics identifier; a network function identity of the network function where data is collected, and/or a target area. The request for analytics may include conditions to provide analytics. The conditions may comprise any combination of a target UE, an area of interest, or a list of S-NSSAI, for example. The analytics may be identified by an analytic ID. The request for analytics information may be a subscription request.

The request for fault information may be derived from the request for analytics. For example, where the request for analytics includes conditions to provide analytics, then these conditions are used to create the request for fault information. The request for fault information may comprise a list of network functions.

The indication as to which analytics are affected by the fault may comprise an indication of the analytics for which the accuracy is affected for the period where the fault occurs.

The indication as to which analytics are affected by the fault may comprise an indication of a time period for which the accuracy of the analytics is affected where the fault occurs. The identity of the particular network function may be defined as a target area, wherein the target area is served by the particular network function. Where the fault affects a plurality of network functions, the plurality of network functions may be defined as a target area, the target area served by the plurality of network functions.

The indication as to which analytics are affected by the fault may comprise an indication of a target area of a plurality of network functions for which the accuracy of the analytics is affected where the fault occurs.

The fault may affect more than the particular network function, in which case the fault information may comprise a target area whereby the fault affects the operation of the of a set of network functions serving the target area. The particular network function may be a member of the set of network functions serving the target area. The fault information may comprise a list of the set of network functions affected by the fault.

As part of Release 18 work for network analytics one objective is to improve the analytics accuracy of NWDAF. In addition, a separate objective of the network analytics study is to determine how NWDAF and MDAS/MDAF functions can interact to improve coordination of analytics between the core network and management plane.

Presented herein is a solution that proposes the NWDAF retrieves from the MDAS/MDAF analytics for fault predictions. Such information can assist the NWDAF to determine if the accuracy of the analytics will be affected. The NWDAF disregards the data from data producer NFs based on the fault prediction information. That is, data from the data producers that is affected by a fault is disregarded.

Prior art solutions generally work by comparing predictions with statistical information. The solution proposed herein is a further optimization to allow the NWDAF to determine scenarios where data collected may be invalid due to a fault occurrence at an NF.

According to the arrangement of FIG. 7, an NWDAF determines accuracy of analytics by subscribing to fault predictions from MDAS/MDAF. However, it should be noted that the present arrangement may also be applied by an NWDAF MTLF, which may determine accuracy of ML model training by subscribing to fault predictions from MDAS/MDAF.

Accordingly, there is provided an NWDAF receiving a first request for Analytics identified by an analytic ID wherein the first request includes first conditions to provide analytics. The analytics may comprise conditions includes a target UE, area of interest, list of S-NSSAI etc. The NWDAF identifies a first list of network functions to collect data to derive analytics for the first request; and sends a second request, which may be a Subscription request, to a first entity, which may be an MDAS/MDAF, to receive statistics and/or predictions for faults taking into account the first conditions requested in the first request and the first list of network functions that provide the data to derive analytics for the first request. The NWDAF determines if analytics accuracy is affected in response to receiving a notification from the first entity on a predicted fault wherein the response includes a time period where the fault is predicted. The NWDAF disregards any data collected between the time period where a fault is predicted in response to determining that the analytics accuracy is affected, and sends a response to the first request indicating analytics accuracy is affected for the period where the fault is predicted.

The second request may include an area of interest, a list of network functions, a network slice instance or a combination thereof.

The response to the second request may include one or more parameters from table 1. These parameters may include an indication of NR cells or NFs where the failure related issues occurred or potentially occur, an event time where the failure occurred or predicted to occur, “Operational Violation”, “Physical Violation” and “Time Domain Violation”, and Severity of the failure.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field of the present document. ML, Machine Learning. MnS, Management service. MDA, Management Data Analytics. MDAS, Management Data Analytics Service. MDAF, Management Data Analytics Function. NF, Network Function. NWDAF, Network Data Analytics Function. OAM, Operations and Maintenance. UE, User Equipment. MTLF, Model Training Logical Function. AnLF, Analytics Inference Logical Function.

1. A network node including a network data analytics function (NWDAF) for wireless communication, the network node comprising:
at least one memory; and
at least one processor coupled with the at least one memory and configured to cause the network node to:
receive a request for analytics, the request for the analytics including a network analytics identifier;
identify from the request for the analytics at least one network function to collect data from;
send, to a management entity, a request for fault information in a wireless communication network;
receive the fault information from the management entity, the fault information including an identity of the network function, a nature of a fault, and a time period where during which the fault affects operation of the network function;
determine if an accuracy of collected data from the network function is affected by the fault information, and disregard any collected data from the network function that is affected by the fault; and
send, in response to the request for the analytics, the analytics and an indication of the analytics that are affected by the fault.

2. The network node of claim 1, wherein the request for the analytics comprises a request for a trained machine learning model associated with the network analytics identifier.

3. The network node of claim 2, wherein to disregard the any collected data from the network function that is affected by the fault, the at least one processor is configured to cause the network node to determine that the trained machine learning model requires retraining.

4. The network node of claim 1, wherein the request for the analytics comprises a request for network analytics corresponding to at least one of the network analytics identifier, a network function identity of the network function where the data is collected, or a target area.

5. The network node of claim 1, wherein the request for the analytics includes conditions.

6. The network node of claim 1, wherein the request for the fault information is derived from the request for the analytics.

7. The network node of claim 1, wherein the indication of the analytics that are affected by the fault comprises an indication of the analytics for which the accuracy is affected for a period of time during which the fault occurs.

8. The network node of claim 1, wherein the indication of the analytics that are affected by the fault comprises an indication of a time period for which the accuracy of the analytics is affected where the fault occurs.

9. The network node of claim 1, wherein the identity of the network function is defined as a target area, and wherein the target area is served by the network function.

10. (canceled)

11. A method performed by a network node that includes a network data analytics function (NWDAF), the method comprising:
receiving a request for analytics, the request for the analytics including a network analytics identifier;
identifying from the request for the analytics at least one network function to collect data from;
sending a request to a management entity, the request including an identity of a particular the network function and a request for fault information within a wireless communication network;
receiving the fault information from the management entity, the fault information including the identity of the network function, a nature of a fault, and a time period during which the fault affects operation of the network function;
determining if an accuracy of collected data from the network function is affected by the fault information, and disregarding any collected data from the network function that is affected by the fault; and
sending, in response to the request for the analytics, the analytics and an indication of the analytics that are affected by the fault.

12. The method of claim 11, wherein the request for the analytics comprises a request for a trained machine learning model, the trained machine learning model trained using training data associated with the network analytics identifier.

13. The method of claim 12, wherein disregarding the any collected data from the network function that is affected by the fault comprises determining that the trained machine learning model requires retraining.

14. The method of claim 11, wherein the request for the analytics comprises a request for network analytics corresponding to at least one of the network analytics identifier, a network function identity of the network function where the data is collected, or a target area.

15. The method of any of claim 11, wherein the request for the analytics includes conditions to provide the analytics.

16. (canceled)

17. The method of any of claim 11, wherein the indication of the analytics that are affected by the fault comprises an indication of the analytics for which the accuracy is affected for a period of time during which the fault occurs.

18-20. (canceled)

21. A processor for wireless communication, comprising:
at least one controller coupled with at least one memory and configured to cause the processor to:
receive a request for analytics, the request for the analytics including a network analytics identifier;
identify from the request for the analytics at least one network function to collect data from;
send a request to a management entity, the request including a request for fault information within a wireless communication network;
receive the fault information from the management entity, the fault information including an identity of the network function, a nature of a fault, and a time period during which the fault affects operation of the network function;
determine if an accuracy of collected data from the network function is affected by the fault information, and disregard any collected data from the network function that is affected by the fault; and
send, in response to the request for the analytics, the analytics and an indication of the analytics that are affected by the fault.

22. The processor of claim 21, wherein the request for the analytics comprises a request for a trained machine learning model associated with the network analytics identifier.

23. The processor of claim 22, wherein to disregard the any collected data from the network function that is affected by the fault, the at least one controller is configured to cause the processor to determine that the trained machine learning model requires retraining.

24. The processor of claim 21, wherein the request for the analytics comprises a request for network analytics corresponding to at least one of the network analytics identifier, a network function identity of the network function where the data is collected, or a target area.

25. The processor of claim 21, wherein the request for the analytics includes conditions.
